(19) United States
(12) Patent Application Publication
(10) Pub. No.: US 2004/0069396 A1
(43) Pub. Date: Apr. 15, 2004

(54) Process for decorating clothing articles with beads

(76) Inventors: Jessica Gabriela Trosman, Buenos Aires (AR); Martin Lazaro Churba, Buenos Aires (AR)

Correspondence Address: GODFREY & KAHN S.C., 780 NORTH WATER STREET, MILWAUKEE, WI, 53202, US

(21) Appl. No.: 10/683,025

(22) Filed: Oct. 9, 2003

Related U.S. Application Data
(62) Division of application No. 09/645,112, filed on Aug. 22, 2000, now abandoned.

(30) Foreign Application Priority Data
Aug. 27, 1999 (AR) P990104310

(51) Int. Cl. B44C 1/00; B32B 31/00

(52) U.S. Cl. 156/63; 156/272.2; 156/276

(57) ABSTRACT

A clothing article comprises a fabric (11) covered in beads (13) rooted to the fabric by means of the mass (19) of the beads in the interstices of the fabric. The beads may be transparent, colourless, coloured or mixtures thereof. Although the process for obtaining the beaded fabric is best suited for random distributions of the beads on the surface of the fabric, it can be also carried out with particular geometric or coloured patterns. A thermo-stamper machine can be used for the process, which essentially comprises arranging loose beads on the fixed plate (15F) of the machine and carrying the beads with the fabric on top and lowering the hot plate (15C) on the fabric, proceeding according to a pre-determined relationship of parameters of the hot plate which include the temperature thereof, the pressure applied to the fabric and the dwell time on the fabric as a function of the material-some low cost plastic-and size of the beads. Preferably, the fabric is arranged in the form of a bag (11′) and the beads are placed therein prior to arranging them on the cold plate. Accessory processes may be carried out for flattening and/or painting the beads on the fabric, carrying out a second pass through the machine with the beaded fabric turned over.

### CROSS REFERENCE TO RELATED APPLICATION

The present application is a divisional of Ser. No. 09/645,112.

### FIELD OF THE INVENTION

The present invention is related to clothing articles, in particular, but may be otherwise applied to other textile articles, covered with beads, spangles or other, like plastic tri-dimensional elements affixed to the fabric. Specifically, the invention discloses a process of anchoring the beads to the fabric or to selected portions thereof, so as to form an article having tridimensional decorative elements, thereby obtaining a fabric useful later for manufacturing clothing articles.

### BACKGROUND OF THE INVENTION

For ages, people have liked to decorate their clothes with beads, spangles and tridimensional elements embedded in selected parts of the clothing such as sleeves and bosoms. Some designs may carry hundreds of beads or more, including very elaborate patterns, having thousands of beads, particularly for special occasions or costumes.

### BRIEF DESCRIPTION OF THE PRIOR ART

The traditional way of anchoring the beads to the fabric or the articles is by embroidery, employing a skilled embroiderer to individually sew the beads on pre-determined points of the fabric. It is an eminently artisan job which may take a qualified embroiderer several days to do just one clothing article.

Also known is another method for decorating a fabric with beads using beads that are flat or faceted on one side, available on the market but rather expensive. The beads are gummed with adhesive for applying to the fabric such as to become affixed thereto. This method has another drawback in that the beads have to be organized before being applied to the fabric and the work time is relatively long.

U.S. Pat. No. 5,169,701 to Sanders discloses anchoring a one-piece vynil decorative item to a T-shirt, leather jacket or the like. U.S. Pat. No. 4,126,727 to Kaminsky discloses a sheet material having embedded decorative chips or flakes for decorative effects. U.S. Pat. No. 5,634,996 to Lewis discloses a method of glueing decorative aluminium studs to a cloth.

### SUMMARY OF THE INVENTION

The present invention discloses a process that drastically reduces the time necessary for obtaining a fabric covered with beads and similar tri-dimensional elements, which is in general applicable to any kind of woven or non-woven fibrous or porous fabric, that is having a microscopic structure, with interstices which may be penetrated and whereinto molten plastic material for the beads may flow so as to anchor the latter in a manner in which it remains rooted to the fabric structure. A relatively simple process has been discovered, to the point that it may be carried out in artisan environments by means of a manual or automatic thermo-stamper machine, relatively fast and uncostly, which may use low quality plastic beads by means of which articles covered in beads are obtained which, surprisingly, convey a high degree of attachments as if they had been individually embroidered by hand and suitable for high-quality clothing articles.

In this way, the invention provides fabrics with tri-dimensional decorations, wherein pre-dyed coloured designs in the fabric may be enhanced by super-imposed beads. The invention also provides for designs by colouring or deforming the same beads by applying accessory processes.

According to the invention, a process is provided which comprises arranging the beads distributed over a lower, fixed plate of the thermo-stamper machine and extending the fabric over the distributed beads and lowering the mobile plates, heated to a pre-determined temperature, on to the fabric, and applying a certain pressure for a pre-determined time. Heat applied to the fabric is transmitted to upper portions of the beads (that is a portion substantially in contact with the lower surface of the fabric) to be melted and such that they penetrate in the pores or interstices of the fabric. The temperature, pressure and time parameters are selected so as to only melt these upper portions of the beads sufficiently for anchorage; the rest of the bead is not heated to the same degree and, therefore, practically suffers no deformation.

Once this time is over, after a few seconds, the fixed plate is lifted again and the fabric is removed from the lower plate, wherein the beads, once the upper portion which has flowed into the structure of the fabric has cooled, sets in this position, forming the aforesaid anchorage. The fabric thus obtained may be directly applied as a clothing article or passed through some supplementary process provided by the present invention as an accessory.

The process of the invention may be readily used for decorating clothes with beads, be they transparent, colourless, coloured or mixtures thereof, randomly arranged over generally flat fabrics. However, it is foreseen that the beads may be arranged in particular geometric arranged patters, such as randomly arranged in rows or with pre-determined colours forming stripes or other kinds of designs, as well as over flattened fabrics.

### DESCRIPTION OF THE DRAWINGS

These and other features, benefits and details of the subject matter of this invention and the manner in which it may be reduced to practice may be better understood by means of the following detailed description, by way of example and without limiting the scope of the invention, of an embodiment depicted in the accompanying drawing wherein:

FIG. 1: View of a fabric decorated with beads randomly distributed according to a basic embodiment of the invention.

FIG. 2A: Schematic cross-section of the fabric and the beads arranged within a thermo-stamper machine in an initial phase of the process of the invention.

FIG. 2B: Schematic similar to FIG. 2A but showing a phase wherein the beads are anchored to the fabric.

FIG. 3: Enlarged detail of a bead anchored to the fabric after the phase of FIG. 2B.

FIG. 4: Schematic similar to FIG. 2A but wherein the process includes previously arranging the fabric in the form of a bag according to another embodiment of the invention.

FIG. 5A: View similar to FIG. 1 but showing a fabric with beads decoratively aligned in rows according to another embodiment of the invention.

FIG. 5B: Schematic similar to FIG. 2A but for providing a fabric with beads decoratively aligned in rows as illustrated in FIG. 5A.

FIG. 6: View of a pre-decorated clothing article prior to applying the process according to the present invention.

FIGS. 7A and 7B: Schematics respectively similar to FIGS. 2A and 2B but illustrating a later process of selectively colouring the beads according to yet another embodiment of the invention.

FIG. 8: View of the fabric of FIG. 1 after applying the accessory process of FIGS. 7A and 7B for obtaining a coloured decorated fabric.

### DESCRIPTION OF PREFERRED EMBODIMENTS OF THE INVENTION

Basic Process:

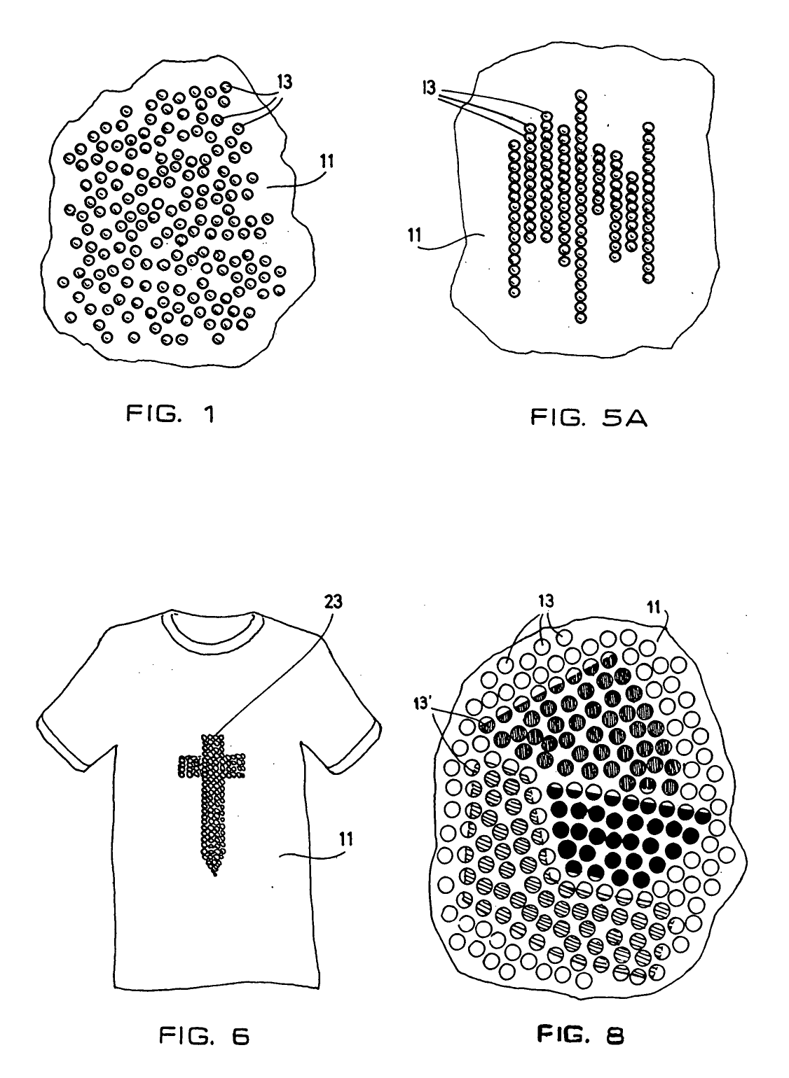

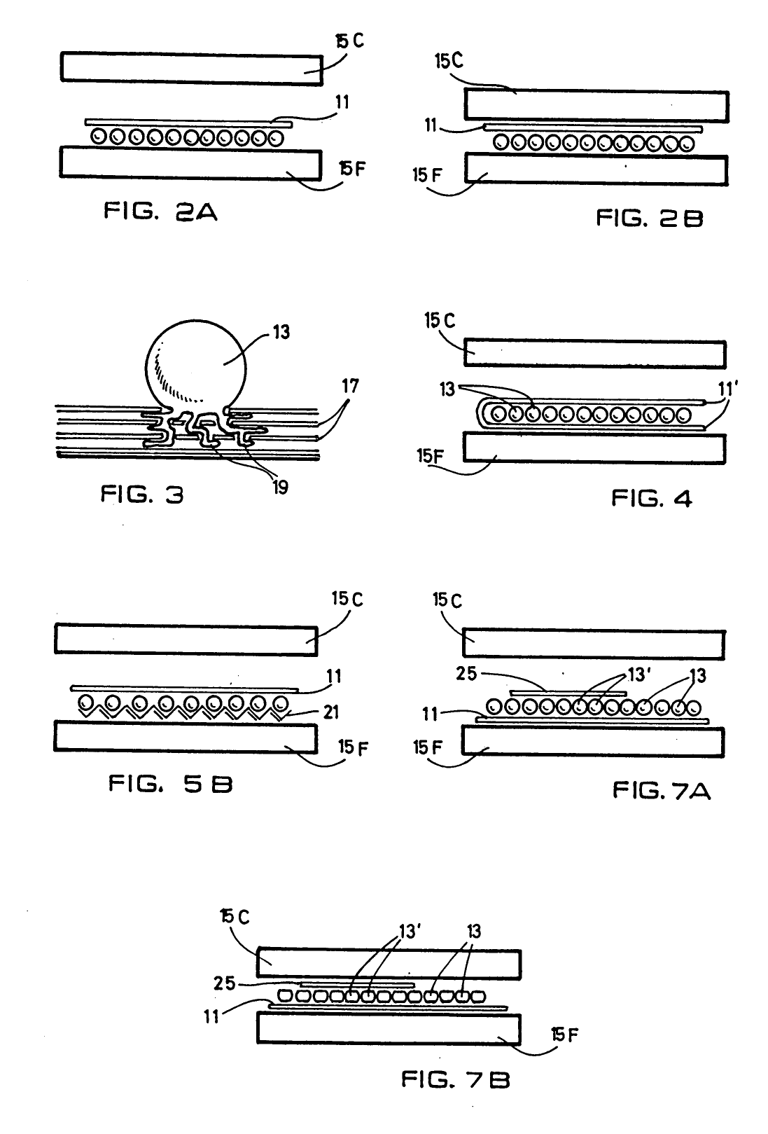

The essential features of the process of the invention for obtaining a fabric 11 covered with beads 13, like the fragment illustrated in FIG. 1, are illustrated by FIGS. 2A and 2B. A manual thermo-stamper machine, such as a German Heinel size 38 cm×31 cm or Greene & Dietrich, model PTE, of one of sizes 50 cm×70 cm or 60 cm×130 cm, is used having a fixed lower plate 15F and a movable plate 15C which can be manually shifted between the positions represented in FIGS. 2A and 2B. The machine includes a handle (not illustrated) for regulating the moment or pressure the movable plate 15C applies downwardly in the pressing position corresponding to FIG. 2B. A heater system (not illustrated) heats the movable plates 15C to a pre-determined temperature controlled by means of an adjustable thermostat. The fixed plate 15F has an upper or work surface of a material, such as Teflon^{MR}, prevents the melted plastic material from sticking thereto.

In FIG. 2A, the initial steps of the process have been carried out, consisting in placing and distributing a mass of beads 13 over the lower plates 15F and placing a fabric 11 on top of the mass of beads. The heated plate 15C is then lowered to press against the upper surface of the fabric 11 applying a regulated pressure, as shown in FIG. 2B, dwelling in this position for a few seconds.

The dwell time depends on parameters such as the temperature of the plates 15C, the pressure applied thereby and the material and size of the beads 13. It is preferable to adjust the temperature towards the higher end of the permissible range, the maximum limit of which is generally determined by the material of the fabric 11, to gain more turn-over.

The following table I shows some test examples using tri-dimensional spherical elements 13 of polystyrene, commercial available as beads for bijouterie and artesian products, using sizes designed for this market and indicating the results obtained insofar the degree of anchorage. The latter was checked by evaluating the force necessary to remove randomly selected beads 13 by hand, as compared with beads embroidered in the traditional manner. In the practice of the invention, the work temperatures generally range between a minimum limit determined by the degree of anchorage and a maximum limit which is conditioned by the based material 11. Polyester enables higher temperatures to be used than nylon, thereby shortening the process time. In the tabled cases, the pressure applied by the plate 15C was adjusted approximately at mid range.

TABLE I

| Fabric 11 | Beads 13 | Plate 15C | Dwell | Anchorage |
|---|---|---|---|---|
| Material | Diameter | Temperature | Time | Results |
| nylon/ | 4-20 mm | 119° C. | 30 sec. | Bad: Unstuck at contact |
| polyester | | | | |
| nylon/ | 20 mm | 125° C. | 30 sec. | Good: Do not come off |
| polyester | | | | |
| nylon/ | 6-20 mm | 137/138° C. | 30 sec. | Good: Do not come off |
| polyester | | | | |
| nylon/ | 4-20 mm | 140° C. | 30 sec. | Good: Do not come off |
| polyester | | | | |
| polyester | 4-20 mm | 190° C. | 2 sec. | Good: Do not come off |
| polyester | 4-20 mm | 232° C. | 2 sec. | Good: Do not come off |

It is easier to work with polyester than with nylon because the latter is limited temperature-wise. Other materials that can be used for the fabric 11 are cotton, silk, wool and rayon, for example, providing structures with the interstices necessary for the present invention.

The result of the process just described is a fabric 11 having beads 13 anchored as schematically shown in FIG. 3. The fabric 11 comprises fibers 17 which are interlinked in a random structure forming, at the microscopic level, interstices to which the molted mass 19 of the beads flows. The rest of the beads 13 does not melt because it is in contact with the cold plate 15F and because the hot plate 15C is incapable of radiating sufficient heat through the air. Only the portions 19 coming into contact with the lower surface of the fabric 11 melt after being heated by the plat 15C in the position of FIG. 2B. The ratio of this portions 19 relative to the total mass of the beads 13, that is the degree that each bead 13 is “pressed”, is mainly determined by the pressure applied by the hot plate 15C against the fabric 11 in this position.

Once the time interval is over, the hot plate 15C is lifted to allow the portions 19 of the beads inside the fabric 11 fibers to cool and consequently harden. By virtue of the plastic nature of the beads 13, the anchor portions 19 practically do not shift from their position once the pressure is off and during hardening, thereby firmly rooting as desired.

Alternative Process for Random Distribution

FIG. 4 illustrates a preferred embodiment of the present invention for obtaining a fabric 11 with a random distribution of beads 13, as shown in FIG. 1. A fabric 11 is provided with three of its sides sewed to form a bag 11′ wherein the beads 13 are inserted. The bag is placed over the cold plate 15F and the beads 13 are spread inside by exerting pressure on the outside against the upper layer of the bag 11′, so that the beads are not bunched together or one on top of another at any point. The beads 13 ere thus randomly distributed inside the bag 11′.

The process follows like the step illustrated in FIG. 2B described above, wherein the fabric 11 described in that figure is formed by the upper side-wall of the bag, in the position of FIG. 4. The beads anchor on the upper wall only of the fabric 11, since only this layer is heated by direct contact with the hot plate 15C. Because the other side-wall, which is in the lower position, is resting on the cold plate 15F, there is no danger of the beads sticking to this latter layer if the pre-determined parameters of this step of the process are not exceeded.

Once the step is over, the bag 11′ is removed from the machine and turned inside out so that the beads 13 are on the outer surface of the bag 11′, the aspect of which is as shown in FIG. 1. Although reference in the present specification is continually made to a fabric, which may be used as part of a clothing article or other textile article, the process for applying beads 13 to the fabric may be used for a fabric which, prior to the process, is already in the form of a clothing article, for example, a T-shirt, a dress, etc. In these cases, for example, it is sufficient to seal the waist opening by folding the T-shirt, without any provisional sewing, and insert the beads 13 therein.

Alternative Process for Distribution According to a Design Pattern:

FIG. 5A shows an article or fabric 11 with beads 13 fixed in a pattern of rows where, by using beads 13 having different aspects, properties—geometry, size, colour and transparency—the distribution of each row may be random or according to a pre-designed pattern. The process is basically as depicted in FIGS. 2A-2B, except that a corrugated flexible member 21, such as cardboard, is previously arranged over the cold plate 15F to thereafter distribute the beads 13 in the corrugations of the cardboard, as shown in FIG. 5B.

FIG. 6 refers to another way of obtaining a colour design with the process of the invention. Fabric 11 is placed on top of the beads 13, in the initial step of FIG. 2A, is an article wherein a design has been previously printed, by dying or imprinting, on the surface designed to receive the beads 13. The process of the invention is then carried out, as described herein referring to FIGS. 2A, 4 or 5B and 2B, to fix the transparent beads 13 over the surface with the design 23 in order to convey a tri-dimensional aspect to the initial design 23, enhancing the articles' attractiveness.

Supplementary Process:

Once one of the processes of the invention previously described herein or variation thereof within the scope of the present invention, an accessory process may be carried out. In FIG. 8, the object is to obtain a decorative design by selectively painting the beads 13 once the anchoring process has terminated, using the same thermo-stamper machine.

The beaded fabric is turned over such that the surface which was in contact with the hot plate 15C now rests on the cold plate 15F, that is the beads 13 face upwards. Transfer papers 25 which transfer dye by sublimation are placed on top of some of the beads 13′, each of a colour determined according to the desired colour design, as shown in FIG. 7A. The hot plate 15C is then lowered on top of the transfer papers 25, which are then heated to transfer the dye by sublimation to the visible portions of the beads 13′.

Moreover, the dyed surface can be faceted by applying some pressure downwards by means of the hot plate 15C. This accessory process can also be carried out alternatively without the colouring paper 25, to simply flatten the visible surfaces of the beads 13, such that they convey a distinctive appearance, such as aging.

Although the present invention has been disclosed in relation to a particular application to certain clothes and articles, it can be likewise applied to other pieces of clothing, such as the sleeve of a party or gala dress, for example, as well as to textile articles other than clothing such as curtains, liners for purses and wallets, shoes, parts thereof, etc. Although round beads 13 are shown in the drawings, the process and product of the invention can just as well contemplate faceted regular or irregular bodies or mixtures of beads 13 having different shapes. The embodiments shown and described herein are merely by way of example, to enable those skilled in the art to understand and practice the principles of the invention. Various modifications, insofar composition, material, arrangement and operation may be carried out without departing from the scope of the invention. Practically all the elements disclosed in the detailed description of the exemplary embodiment are subject to variations in greater or lesser degree of economy, adherence, attractiveness, etc.

We claim:

1. A process for obtaining a tridimensionally-decorated fabric, said process comprising the steps of:
(a) providing a fabric and a plurality of decorative tridimensional elements, said fabric being fibrous or porous of the type providing interstices and including a surface to be decorated or otherwise aesthetically improved;
(b) arranging said plurality of decorative tridimensional elements over a first work surface;
(c) covering the tridimensional elements with the fabric such that said surface thereof lies and may contact an exposed part of the surface of said tridimensional elements;
(d) applying heat and pressure during a time interval to the surface of said fabric opposite to said surface, wherein said pressure is applied in a direction to urge said fabric against said work surface sufficiently and limit said heat, pressure and time interval to melt the exposed part of the tridimensional elements so as to substantially penetrate said interstices without substantially deforming the rest of each of said tridimensional elements; and
(e) allow said melted part of said tridimensional elements to set.

2. A process according to claim 1, wherein said work surface is a non-tacky top surface of a cold plate and said step (d) comprises applying the lower surface of a movable hot plate to said fabric, said plate forming part of a thermo-stamper type of machine.

3. A process according to claim 1, wherein said fabric is polyester and said movable plate is at a pre-determined temperature within the range of 125° to 232° C. at the beginning of said step (d).

4. A process according to claim 3, wherein said pressure and time intervals are selected inversely proportional to said pre-determined temperature.

5. A process according to claim 4, wherein said movable plate is at a pre-determined temperature of between 190° and 200° C. at the beginning of said step (d) and said time interval is selected to be around 2 seconds.

6. A process according to claim 1, wherein said steps (b) and (c) are carried out in combination by means of the steps of:
said steps (b) and (c) are carried out in combination by means of the steps of:
arranging the fabric in the shape of a bag,
inserting the tridimensional elements in the bag and
resting the bag with one of its sides over the work surface and substantially flattening the opposite side of the bag to spread out the inserted tridimensional elements;
said step (d) comprises applying heat and pressure during said time interval to said opposite side of said bag; and
said step (e) comprises removing the fabric in the shape of the bag from the work surface and turning it inside out such that the tridimensional elements are on the outside.

7. A process according to claim 1, wherein said work surface is corrugated.

8. A process according to claim 2, wherein a corrugated surface is previously arranged over the fixed plate of the thermo-stamper machine.

9. A process according to claim 1, further including the steps after (e) of:
(f) turn over the fabric with the tridimensional elements and arrange it over the work surface so as to expose the tridimensional elements;
(g) place at least one coloured transfer paper over a selected region containing tridimensional elements rooted to said fabric and
(h) apply heat until colour is transmitted by sublimation to said paper to said tridimensional elements in said region.

10. A process according to claim 9, further including the steps after (e) of:
(f) turn over the fabric with the tridimensional elements and arrange it over the work surface so as to expose the tridimensional elements,
(g) place at least one coloured transfer paper over a selected region containing tridimensional elements rooted to said fabric and
(h) apply heat until colour is transmitted by sublimation to said paper to said tridimensional elements in said region,
wherein the steps (f) to (h) are carried out with the same thermo-stamper machine as steps (a) to (e).

11. A process according to claim 1, wherein said tridimensional elements are made of plastic material which is meltable at a temperature lower than that of the material of said fabric whereby said elements become anchored to said fabric by portions of its own plastic material partially diffused in said fabric interstices.

12. A process according to claim 11, wherein said plastic material is polystyrene.

13. A process according to claim 1, wherein said tridimensional elements include beads selected from a group comprised by spherical beads, faceted beads, transparent beads and combinations thereof.

14. A process according to claim 1, wherein said fabric material is nylon or polyester.

15. A process according to claim 1, wherein step (b) includes substantially randomly distributing said tridimensional elements over a first work surface.

16. A process according to claim 1, wherein step (a) comprises providing a fabric imaged with a bidimensional design and substantially transparent tridimensional elements.

17. A process according to claim 1, wherein step (a) comprises providing said fabric and tridimensional elements of a plurality of different colours and step (b) includes substantially distributing said tridimensional elements in groups or stripes of different colours.

18. A process according to claim 1, wherein step (a) comprises providing tridimensional elements each having a substantially flat surface and step (b) includes aranging said tridimensional elements with said flat surfaces thereof lying on said plate.

19. A process according to claim 1, further including a latter step of manufacturing a decorative clothing article using said tridimensionally-decorated fabric.
